(19) United States
(12) Patent Application Publication
(10) Pub. No.: US 2020/0341729 A1
(43) Pub. Date: Oct. 29, 2020

(54) VOICE OPERATION SYSTEM, VOICE OPERATION DEVICE, VOICE OPERATION CONTROL METHOD, AND RECORDING MEDIUM HAVING VOICE OPERATION CONTROL PROGRAM RECORDED THEREIN

(71) Applicant: HONDA MOTOR CO., LTD., Tokyo (JP)

(72) Inventors: Takahiro Tanaka, Wako-shi (JP); Masaro Koike, Wako-shi (JP); Junichiro Onaka, Wako-shi (JP); Masahiro Kurehashi, Wako-shi (JP)

(21) Appl. No.: 16/852,980

(22) Filed: Apr. 20, 2020

(30) Foreign Application Priority Data
Apr. 24, 2019 (JP) 2019-082512

(51) Int. Cl. G06F 3/16; G10L 15/22; G10L 15/08; G10L 25/51

(52) U.S. Cl. CPC G06F 3/167; G10L 15/22; G10L 2015/225; G10L 25/51; G10L 15/08

(57) ABSTRACT

The voice operation system includes an indication candidate determination unit for extracting an indication element included in a user's utterance, and determining a first indication candidate which is a candidate of an indication content intended by the user based on the indication element and a behavioral habit of the user U estimated by a behavioral habit estimation unit when the indication content intended by the user U cannot be specified from the indication element, a predetermined processing execution unit for executing first predetermined processing corresponding to the first indication candidate, and a display control unit for causing a display unit to display at least one of the content of the first indication candidate and the execution content of the first predetermined processing.

### INCORPORATION BY REFERENCE

The present application claims priority under 35 U.S.C. § 119 to Japanese Patent Application No. 2019-08512 filed on Apr. 24, 2019. The content of the application is incorporated herein by reference in its entirety.

### BACKGROUND OF THE INVENTION

### Field of the Invention

The present invention relates to a voice operation system, a voice operation device, a voice operation control method, and a recording medium having a voice operation control program recorded therein.

### Description of the Related Art

An in-vehicle voice recognition device has been conventionally known which recognizes utterance of a geographical name by a driver of a vehicle and displays a recognition result on a display unit (for example, see Japanese Patent Laid-Open No. 2006-349427).

In the above-described conventional in-vehicle voice recognition device, a traveling history of a vehicle is stored for each driver to configure a voice recognition dictionary based on the traveling history, and voice recognition is performed on driver's utterance using the voice recognition dictionary.

### SUMMARY OF THE INVENTION

In the above-described conventional in-vehicle voice recognition device, particularly when a sentence of an utterance is long, a driver is likely to make a misstatement. When the driver makes a misstatement, the driver is annoyed because the driver has to make the utterance again. Therefore, in order to make it easy for a user to perform a voice operation, it is considered to estimate an ambiguous indication using a short utterance sentence by AI (Artificial Intelligence) or the like to specify a user's indication content. However, in this case, the indication content specified by the estimation may be different from an indication intended by the user in some cases.

The present invention has been made in view of such a background, and has an object to provide a voice operation system, a voice operation device, a voice operation control method, and a voice operation control program, which enable acceptance of an indication intended by a user according to a user's simple utterance.

According to a first aspect to achieve the above object, there is provided a voice operation system including: an utterance recognition unit for recognizing an utterance of a user; a behavioral habit estimation unit for estimating a behavioral habit of the user; an indication candidate determination unit for extracting an indication element contained in an utterance of the user when the utterance of the user is recognized by the utterance recognition unit, and determining a first indication candidate which is a candidate of an indication content intended by the user based on the indication element and the behavioral habit of the user estimated by the behavioral habit estimation unit when the indication content intended by the user cannot be specified from the indication element; a predetermined processing execution unit for executing first predetermined processing corresponding to the first indication candidate; and a display control unit for causing a display unit to display at least one of a content of the first indication candidate and an execution content of the first predetermined processing.

The above-described voice operation system may further include a cancel operation acceptance unit for accepting a cancel operation by the user, wherein in a case where at least one of the content of the first indication candidate and the execution content of the first predetermined processing is displayed on the display unit, the predetermined processing execution unit may cancel execution of the first predetermined processing when the cancel operation is accepted by the cancel operation acceptance unit.

In the above-described voice operation system, in a case where at least one of the content of the first indication candidate and the execution content of the first predetermined processing is displayed on the display unit, the indication candidate determination unit may determine a second indication candidate which is a candidate of the indication content intended by the user based on the indication element and a predetermined selection condition which does not depend on the behavioral habit when the cancel operation is accepted by the cancel operation acceptance unit; the predetermined processing execution unit may execute second predetermined processing corresponding to the second indication candidate; and the display control unit may cause the display unit to display at least one of the second indication candidate and an execution content of the second predetermined processing.

In the above-described voice operation system, the voice operation system may be used to indicate a search condition for a destination in a navigation device; when a common name to a plurality of shops is extracted as the indication element indicating a destination, the indication candidate determination unit may determine the first indication candidate indicating, as a first search condition for the destination, a shop which has been previously used by the user among the plurality of shops; and the predetermined processing execution unit may execute, as the first predetermined processing, processing of searching the shop which has been previously used by the user, based on the behavioral habit of the user according to the first search condition.

In the above-described voice operation system, the voice operation system may be used to indicate a destination in a navigation device; when a common name to a plurality of shops is extracted as the indication element indicating a destination, the indication candidate determination unit may determine the first indication candidate indicating, as a first search condition for the destination, a shop which has been previously used by the user among the plurality of shops, and when the cancel operation is accepted by the cancel operation acceptance unit, by utilizing, as the selection condition, a condition of being closest to a current place of the navigation device, the indication candidate determination unit may determine the second indication candidate indicating a shop closest to the current place of the navigation device among the plurality of shops as a second search condition for the destination; and the predetermined processing execution unit may execute, as the first predetermined processing, processing of searching the shop which has been previously used by the user, based on the behavioral habit of the user according to the first search condition, and execute, as the second predetermined processing, processing of searching the shop closest to the current position of the navigation device according to the second search condition.

According to a second aspect to achieve the above object, there is provided a voice operation device including a display unit and an utterance recognition unit for recognizing an utterance of a user, including: a behavioral habit estimation unit for estimating a behavioral habit of the user; an indication candidate determination unit for extracting an indication element contained in an utterance of the user when the utterance of the user is recognized by the utterance recognition unit, and determining a first indication candidate which is a candidate of an indication content intended by the user based on the indication element and the behavioral habit of the user estimated by the behavioral habit estimation unit when the indication content intended by the user cannot be specified from the indication element; a predetermined processing execution unit for executing first predetermined processing corresponding to the first indication candidate; and a display control unit for causing the display unit to display at least one of a content of the first indication candidate and an execution content of the first predetermined processing.

According to a third aspect to achieve the above object, there is provided a voice operation control method to be executed by a single or a plurality of computers, including: an utterance recognition step of recognizing an utterance of a user; an indication element extraction step of extracting an indication element contained in an utterance of the user when the utterance of the user is recognized; a behavioral habit estimation step of estimating a behavioral habit of the user; an indication candidate determination step of determining a first indication candidate which is a candidate of an indication content intended by the user based on the indication element and the behavioral habit of the user estimated by the behavioral habit estimation step when the indication content intended by the user cannot be specified from the indication element; a predetermined processing execution step of executing first predetermined processing corresponding to the first indication candidate; and a display control step of causing a display unit to display at least one of a content of the first indication candidate and an execution content of the first predetermined processing.

According to a fourth aspect to achieve the above object, there is provided a recording medium having a voice operation control program recorded therein, the non-transistor recording medium being installed in a single or a plurality of computers, the voice operation control program causing the single or the plurality of computers to execute: utterance recognition processing of recognizing an utterance of a user; indication element extraction processing of extracting an indication element contained in an utterance of the user when the utterance of the user is recognized; behavioral habit estimation processing of estimating a behavioral habit of the user; indication candidate determination processing of determining a first indication candidate which is a candidate of an indication content intended by the user based on the indication element and the behavioral habit of the user estimated by the behavioral habit estimation processing when the indication content intended by the user cannot be specified from the indication element; predetermined processing execution processing of executing first predetermined processing corresponding to the first indication candidate; and display control processing of causing a display unit to display at least one of a content of the first indication candidate and an execution content of the first predetermined processing.

According to the above-described voice operation system, when an indication content intended by a user cannot be specified from an indication element included in the utterance of the user, a first indication candidate which is a candidate of an indication content intended by the user is determined based on an indication element and a behavioral habit of the user estimated by the behavioral habit estimation unit by the indication candidate determination unit. At least one of the content of the first indication candidate and the execution content of the first processing executed according to the first indication candidate is displayed on the display unit by the display control unit. As a result, by uttering a part of an operation instruction as an indication element, the user can easily perform the operation instruction while checking the first indication candidate or the execution content of the first predetermined processing. Therefore, it is possible to suppress occurrence of a misstatement or erroneous recognition caused by user's long utterance of an entire operation instruction, and simplify the operation instruction by voice.

### BRIEF DESCRIPTION OF THE DRAWINGS

FIG. 1 is a configuration diagram of a navigation device including a function of a voice operation system;

FIG. 2 is an explanatory diagram of user data;

FIG. 3 is a flowchart of processing of determining a first search condition for a destination based on a user's behavioral habit;

FIG. 4 is a flowchart of processing of determining a second search condition for a destination based on a predetermined selection condition;

FIG. 5 is an explanatory diagram of a screen for displaying the first search condition for the destination and an execution content of first search processing corresponding to the first search condition; and

FIG. 6 is an explanatory diagram of a screen for displaying the second search condition for the destination and an execution content of second search processing corresponding to the second search condition.

### DETAILED DESCRIPTION OF THE PREFERRED EMBODIMENT

### [1. Configuration of Voice Operation System]

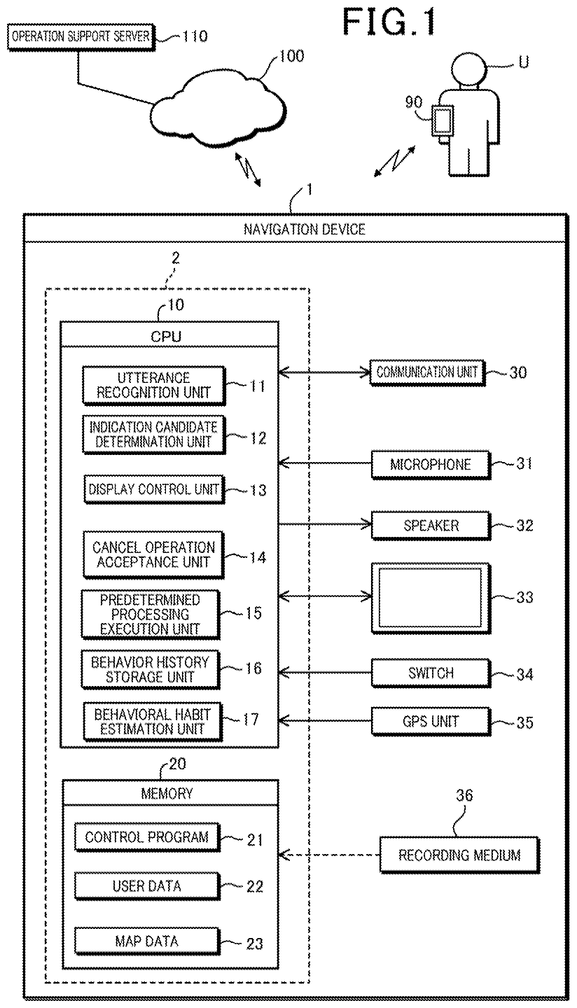

A configuration of a voice operation system 2 of this embodiment will be described with reference to FIG. 1. The voice operation system 2 is configured as a part of the function of a navigation device 1 installed in a vehicle (not shown). Note that the present embodiment includes the navigation device 1 installed in the vehicle, but may include a portable type navigation device. Further, the present embodiment may include a navigation device which is configured by executing an application for navigation (application program) installed in a portable terminal such as a smartphone.

The navigation device 1 includes a CPU (Central Processing Unit) 10, a memory 20, a communication unit 30, a microphone 31, a speaker 32, a touch panel 33, a switch 34, and a GPS (Global Positioning System) unit 35. The communication unit 30 communicates with an external system such as an operation support server 110 via a communication network 100. Further, the communication unit 30 communicates with a user terminal 90 used by a user U of the navigation device 1 via the communication network 100 or directly. The user terminal 90 is a portable type communication terminal such as a smartphone, a tablet terminal, or a portable phone.

The microphone 31 inputs a voice of the user U. The speaker 32 outputs voice guidance and the like for the user U. The touch panel 33 is configured to include a flat type display unit such as a liquid crystal panel, and a touch switch disposed on a surface of the display unit. The switch 34 is pressed to be operated by the user U. The GPS unit 35 detects the current position of the navigation device 1 by receiving electric waves transmitted from a GPS satellite. The voice operation device of the present invention is configured by the voice operation system 2 and the touch panel 33.

The navigation device 1 sets a destination according to a touch operation on the touch panel 33 by the user U or an operation based on a user's voice input to the microphone 31. The navigation device 1 performs route guidance up to the destination based on the current position of the navigation device 1 detected by the GPS unit 35 (the current position of the vehicle in which the navigation device 1 is installed), and map data 23 stored in the memory 20. Note that the map data may be obtained by accessing an external server such as the operation support server 110 via the communication unit 30.

The voice operation system 2 is configured to include the CPU 10, the memory 20, and the like. The CPU 10 reads and executes (by installing) a control program 21 for the voice operation system 2 stored in the memory 20, thereby functioning as an utterance recognition unit 11, an indication candidate determination unit 12, a display control unit 13, a cancel operation acceptance unit 14, a predetermined processing execution unit 15, a behavior history storage unit 16, and a behavioral habit estimation unit 17. The CPU 10 corresponds to a single or a plurality of computers of the present invention, and executes a voice operation control method. The control program 21 includes a voice operation control program of the present invention. The data of the control program 21 may be recorded in a non-transitory recording medium 36 (flash memory, magnetic disk, optical disk or the like), and transferred from the recording medium 36 to the memory 20.

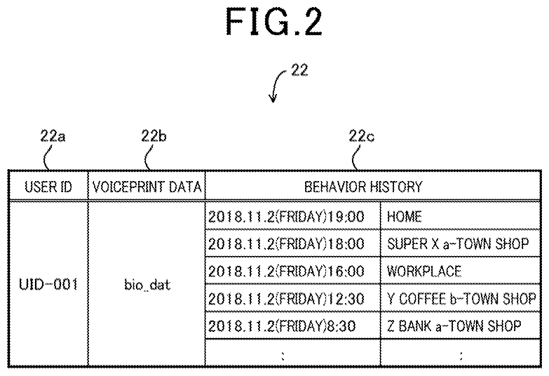

The behavior history storage unit 16 stores, in user data 22, a behavior history indicating locations to which the user U has moved so far, and date and time when the user U has moved so far. Based on the current position of the navigation device 1 detected by the GPS unit 35, the behavior history storage unit 16 recognizes a location to which the user U has moved, and records the recognized location into a behavior history. As shown in FIG. 2, the user data 22 includes a user ID 122a, biometric data 22b for identifying a user, and a behavior history 22c, which are stored in the user data 22 for each of a plurality of users who use a vehicle in which the navigation device 1 is installed. The biometric data 22b includes data for performing biometrics authentication such as a face image, a voiceprint, an iris, and a fingerprint. FIG. 2 is an explanatory diagram showing the user data 22 for the user U.

The utterance recognition unit 11 analyzes the voice of the user U input to the microphone 31 to recognize an utterance content of the user U. The indication candidate determination unit 12 determines a first search condition (corresponding to a first indication candidate of the present invention) for a destination intended by the user U based on the utterance content of the user U recognized by the utterance recognition unit 11 and the behavior history 22c recorded in the user data 22. Further, the indication candidate determination unit 12 determines a second search condition (corresponding to a second indication candidate of the present invention) for the destination intended by the user U based on the utterance content of the user U recognized by the utterance recognition unit 11 and a predetermined selection condition.

The predetermined processing execution unit 15 executes first search processing (corresponding to first predetermined processing of the present invention) based on the first search condition for the destination, and second search processing (corresponding to second predetermined processing of the present invention) based on the second search condition for the destination. The display control unit 13 displays, on the touch panel 33, the first search condition and an execution content of the first search processing, and the second search condition and an execution content of the second search processing. The cancel operation acceptance unit 14 accepts a cancel operation of the first search condition by the user U. The cancel operation acceptance unit 14 recognizes the touch operation on the touch panel 33 by the user U or the voice of the user U input to the microphone 31 to accept the cancel operation.

The behavioral habit estimation unit 17 estimates a behavioral habit of the user U from the behavior history 22c recorded in the user data 22. The behavioral habit estimation unit 17 estimates behavioral habits as described below, for example.

(1) The frequency at which the user U drinks coffee at coffee shops on weekdays is high.
(2) The time at which the user U returns home on weekdays is around 19:00.
(3) The user U may drop in at a supermarket on user's way home from the workplace on weekdays.
(4) When the user U goes out of the workplace, the user often returns to the workplace around 16:00.

### [2. Processing of Determining Search Condition for Destination]

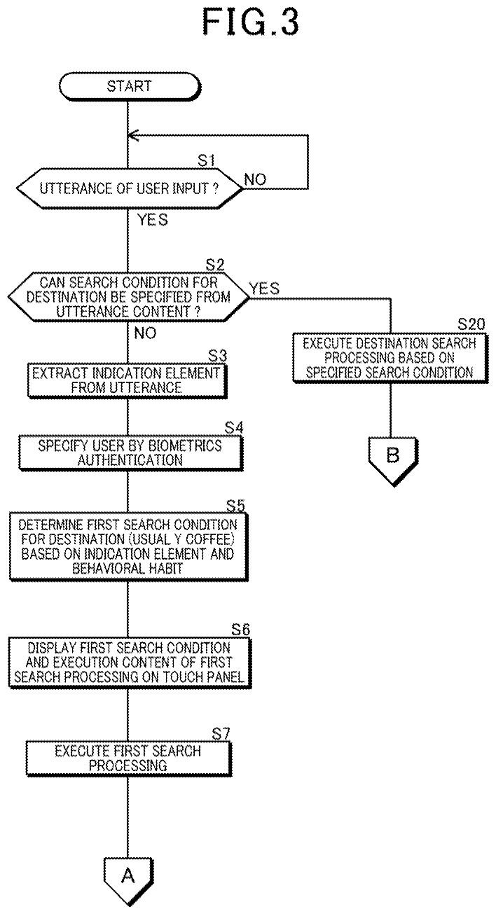

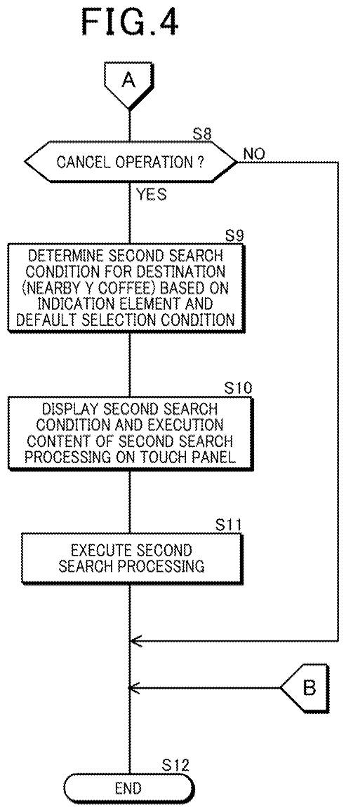

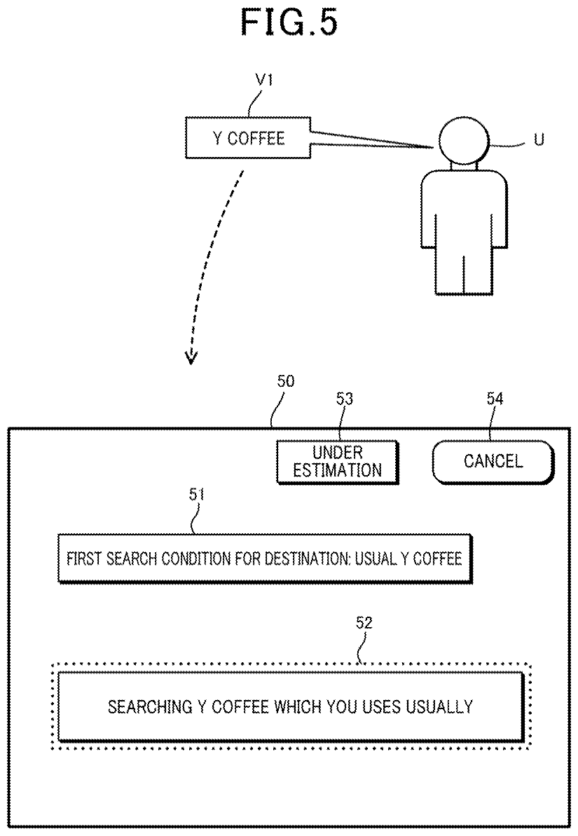

Processing of determining a search condition for a destination to be executed by the voice operation system 2 when the user U gives an utterance V1 indicating a destination as shown in FIG. 5 will be described according to flowcharts shown in FIGS. 3 and 4. In step S1 in FIG. 3, when the utterance recognition unit 11 recognizes an utterance of the user U from a user' voice input to the microphone 31, the utterance recognition unit 11 advances the processing to step S2. The processing of recognizing the utterance of the user U in step S2 corresponds to an utterance recognition step in the voice operation control method of the present invention, and also corresponds to utterance recognition processing in the voice operation control program of the present invention.

In step S2, the utterance recognition unit 11 determines whether the search condition for the destination (an indication content by the user U) can be specified from the utterance content. The utterance recognition unit 11 advances the processing to step S20 when the search condition can be specified, but advances the processing to step S3 when the search condition cannot be specified. In step S20, the predetermined processing execution unit 15 executes the search processing for the destination based on the specified search condition, and advances the processing to step S13 in FIG. 4.

In the example of FIG. 5, an utterance V1 of “Y coffee” has been recognized by the utterance recognition unit 11. However, it is unclear which shop the user U intends by “Y coffee” because there are a plurality of stops having a common name of “Y coffee”. Therefore, the indication candidate determination unit 12 estimates a search condition for the “Y coffee” intended by the user U.

In step S3, the indication candidate determination unit 12 extracts “Y coffee” as an indication element of the destination from the utterance V1 of the user U. The processing of extracting the indication element in step S3 corresponds to an indication element extraction step in the voice operation control method of the present invention, and also corresponds to indication element extraction processing in the voice operation control program of the present invention. In subsequent step S4, the indication candidate determination unit 12 identifies the user U by biometrics authentication based on a voiceprint, and refers to a behavioral habit of the user U estimated by the behavioral habit estimation unit 17 in step S5. Note that biometrics authentication based on a face image, fingerprint, iris, or the like may be performed instead of biometrics authentication based on the voiceprint.

Here, it is assumed that “the frequency at which the user U drinks coffee at a coffee shop is high” has been estimated as a behavioral habit of the user U by the behavioral habit estimation unit 17. The processing of estimating the behavioral habit of the user U by the behavioral habit estimation unit 17 corresponds to a behavioral habit estimation step in the voice operation control method of the present invention, and also corresponds to behavioral habit estimation processing in the voice operation control program of the present invention.

Since the frequency at which the user U utilizes a coffee shop is high, the indication candidate determination unit 12 selects “usual” as an optional element for the destination search, and sets “usual Y coffee” as the first search condition for the destination. The processing of determining the first search condition (corresponding to the first indication candidate of the present invention) by the indication candidate determination unit 12 corresponds to an indication candidate determination step in the voice operation control method of the present invention, and also corresponds to indication candidate determination processing in the voice operation control program of the present invention.

In subsequent step S6, the display control unit 13 displays, on the touch panel 33, a first search screen 50 including a display 51 of the first search condition for the destination (usual Y coffee), and a display 52 of an execution content of the first search processing based on the first search condition (the Y coffee which you usually utilize is being searched) as shown in FIG. 5. On the first search screen 50 are displayed an under-estimation display 53 indicating that the destination intended by the user U is being estimated, and a cancel button 54 for accepting a cancel operation of the first search condition by the user U. The processing in step S6 corresponds to a display control step in the voice operation control method of the present invention, and also corresponds to display control processing in the voice operation control program of the present invention.

By visually recognizing the first search screen 50, the user U can check that the first search condition for the destination determined for the utterance of “Y coffee” is “usual Y coffee”, and a Y candidate which the user U usually utilizes is being searched. In next step S7, the predetermined processing execution unit 15 refers to the behavior history 22c of the user U, and recognizes from an actual usage record of the user U that “usual Y coffee” is “Y coffee b-town shop”. The predetermined processing execution unit 15 refers to the map data 23 to execute first search processing of searching the location of “Y coffee b-town shop”. The processing of executing the first search processing (corresponding to the first predetermined processing of the present invention) by the predetermined processing execution unit 15 corresponds to a predetermined processing execution step in the voice operation control method of the present invention, and also corresponds to predetermined processing execution processing in the voice operation control program of the present invention.

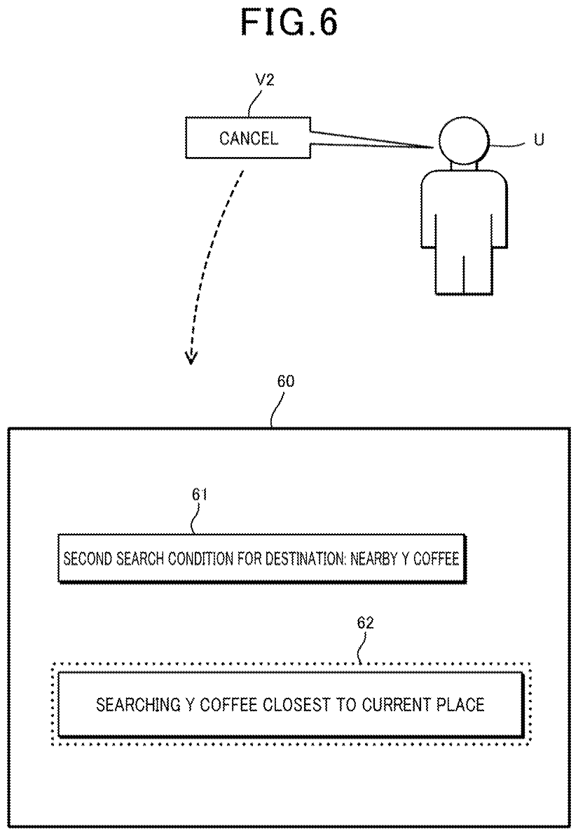

In subsequent step S8 in FIG. 4, the cancel operation acceptance unit 14 determines whether a cancel operation has been performed by the user U. The cancel operation acceptance unit 14 accepts the cancel operation by the user U when the cancel button 54 on the first search screen 50 shown in FIG. 5 is operated or an utterance V2 of “cancel” by the user U is recognized as shown in FIG. 6. Accordingly, the user U can easily cancel the search condition when the first search condition of “usual Y coffee” is not intended by the user U.

When the cancel operation acceptance unit 14 accepts the cancel operation by the user U, the cancel operation acceptance unit 14 advances the processing to step S9. On the other hand, when the cancel operation acceptance unit 14 does not accept the cancel operation by the user U, the cancel operation acceptance unit 14 advances the processing to step S13, and in this case, the shop of Y coffee which has been searched based on the first search condition of “usual Y coffee” (Y coffee b-town shop in the example of FIG. 2) is settled as the destination.

In step S9, the indication candidate determination unit 12 determines a second search condition of “near Y coffee” based on the indication element of “Y coffee” and a default selection condition of “near”. In subsequent step S10, the display control unit 13 displays, on the touch panel 33, a second search screen 60 including a display 61 of the second search condition for the destination (near Y coffee) and a display 62 of an execution content of the second search processing corresponding to the second search condition (Y coffee closest to the current position is being searched) as shown in FIG. 6. In subsequent step S11, the predetermined processing execution unit 15 refers to the map data 23 to execute the second search processing of searching a shop of Y coffee closest to the current position of the navigation device 1 as “nearby Y coffee”.

As described above, when the user U wants to go to the “Y coffee b-town stop” which the user U usually uses, the user U can set the “Y coffee b-town shop” as a destination by making a short utterance of “Y coffee”. Further, when the user U wants to go to a nearby “Y coffee” instead of the usually used “Y coffee”, the user U may make an utterance V2 of “cancel” as shown in FIG. 6 or perform a touch operation of the cancel button 54 shown in FIG. 5. Therefore, it can be avoided that a destination against a user's intention is set due to a misstatement or misrecognition of voice which is likely to occur when a search condition for a destination is input with a long utterance such as “set Y coffee b-town shop as the destination”, and thus a troublesome operation of making an utterance again to correct the destination or the like is required.

### 3. Other Embodiment

The above-described embodiment has been described by using an example in which the voice operation system 2 is configured as a part of the function of the navigation device 1 and a shop is searched as a destination. However, the destination is not limited to a shop, and may be a home or a workplace. For example, when the user U utters “return”, “return” may be extracted as an indication element, “home” may be selected as an optional element from the behavioral habit of the user U, and “return home” may be determined as a first search condition (corresponding to a first indication candidate) based on “return” and “home”. In this case, when the user U performs the cancel operation, “workplace” may be selected as an optional element, and “Return to workplace” may be determined as a second search condition based on “return” and “workplace”. Further, according to the time at which the user U utters “return”, when the utterance time is within a predetermined time before and after a past return-home time (19:00 in FIG. 2), “return home” is determined as the first search condition. When the utterance time is within a predetermined time before and after a past return-to-workplace time (16:00 in the example of FIG. 2), “return to workplace” may be determined as the first search condition.

Further, when the user U gives an indication of an inquiry about a specific place such as “tell me a nearby supermarket” or “tell me a nearby Y coffee” on a specific date and time and day of the week, the indication candidate determination unit may recognize “usual supermarket” or “usual Y coffee” from the indication based on the behavioral habit of the user U, and determines the first search condition (corresponding to the first indication candidate).

In the above-described embodiment, the voice operation system 2 is configured as a part of the function of the navigation device 1. However, the voice operation system 2 may be configured as a part of another type of device such as a home appliance, or a dedicated device. For an utterance of an indication other than the search condition for the destination by the user, a first indication candidate may be determined based on an indication element extracted from the utterance and a user's behavioral habit. For example, for a voice operation system targeting an air conditioner, in response to an utterance of “ON timer”, a set time of the ON timer may be set based on the user's behavioral habit so as to be different between weekdays and holidays.

Further, the voice operation system 2 may be configured as a voice operation unit of a radio receiver. In response to an indication using a user's utterance of only “turn on radio”, based on the user's behavioral habit, a radio station to be received (a broadcast frequency of FM, AM, satellite or the like is specified by a broadcast station name, a channel name or the like) may be set a radio broadcasting station to which the user listens frequently in a time zone in which the utterance is made. Further, in this case, a radio station may be determined based on the user's behavioral habit so as to be different between weekdays and holidays.

Further, the configuration of the voice operation system 2 may be equipped to the operation support server 110. In this case, the operation support server 110 receives utterance data of the user U transmitted from the navigation device 1, extracts an indication element, and determines a first indication candidate based on the indication element and the user's behavioral habit, and a second indication candidate based on the indication element and a predetermined selection condition. The operation support server 110 becomes an embodiment for transmitting information on the first indication candidate and the second indication candidate to the navigation device 1.

The above-described embodiment is configured to include the cancel operation acceptance unit 14 and select a second option element according to a cancel operation of the user to determine a second indication candidate. However, the above-described embodiment may be configured to omit the cancel operation acceptance unit 14.

In the above-described embodiment, as shown in FIG. 5, the display 51 of the first search condition (corresponding to the first indication candidate) and the display 52 of the execution content of the first search processing (corresponding to the first predetermined processing) are displayed on the first search screen 50. However, only one of the display 51 of the first search condition and the display 52 of the execution content of the first search processing may be displayed. Likewise, only one of the display 61 of the second search condition (corresponding to the second indication candidate) and the display 62 of the execution content of the second search processing (corresponding to the second predetermined processing) may be displayed on the second search screen 60 shown in FIG. 6.

In the above-described embodiment, the voice of the user U is input with the microphone 31 provided in the vehicle, and the first search screen 50 and the second search screen 60 are displayed on the touch panel 33 provided in the vehicle. As another configuration, the voice of the user U may be input with a microphone (not shown) provided in the user terminal 90, and voice data may be transmitted from the user terminal 90 to the navigation device 1. Further, data of the first search screen 50 and the second search screen 60 may be transmitted from the navigation device 1 to the user terminal 90 to display the first search screen 50 and the second search screen 60 on the screen of the user terminal 90.

Note that FIG. 1 is a schematic diagram showing a functional configuration of the voice operation system 2 which is segmented according to main processing contents in order to facilitate understanding of the invention of the present application, and the voice operation system 2 may be optionally configured according to another segmentation. Further, the processing of each component may be executed by one hardware unit, or may be executed by a plurality of hardware units. Still further, the processing of each component may be executed by one program, or may be executed by a plurality of programs.

### REFERENCE SIGNS LIST

1 navigation device,
2 voice operation system,
10 CPU,
11 utterance recognition unit,
12 indication candidate determination unit,
13 display control unit,
14 cancel operation acceptance unit,
15 predetermined processing execution unit,
16 behavior history storage unit,
17 behavioral habit estimation unit,
20 memory,
21 control program,
22 user data,
23 map data,
30 communication unit,
31 microphone,
32 speaker,
33 touch panel,
34 switch,
35 GPS unit,
36 non-transitory recording medium,
50 first search screen,
54 cancel button,
60 second search screen,
90 user terminal,
100 communication network,
110 operation support server.

What is claimed is:

1. A voice operation system comprising:
an utterance recognition unit for recognizing an utterance of a user;
a behavioral habit estimation unit for estimating a behavioral habit of the user;
an indication candidate determination unit for extracting an indication element contained in an utterance of the user when the utterance of the user is recognized by the utterance recognition unit, and determining a first indication candidate which is a candidate of an indication content intended by the user based on the indication element and the behavioral habit of the user estimated by the behavioral habit estimation unit when the indication content intended by the user cannot be specified from the indication element;
a predetermined processing execution unit for executing first predetermined processing corresponding to the first indication candidate; and
a display control unit for causing a display unit to display at least one of a content of the first indication candidate and an execution content of the first predetermined processing.

2. The voice operation system according to claim 1, further comprising a cancel operation acceptance unit for accepting a cancel operation by the user, wherein in a case where at least one of the content of the first indication candidate and the execution content of the first predetermined processing is displayed on the display unit, the predetermined processing execution unit cancels execution of the first predetermined processing when the cancel operation is accepted by the cancel operation acceptance unit.

3. The voice operation system according to claim 2, wherein in a case where at least one of the content of the first indication candidate and the execution content of the first predetermined processing is displayed on the display unit,
the indication candidate determination unit determines a second indication candidate which is a candidate of the indication content intended by the user based on the indication element and a predetermined selection condition which does not depend on the behavioral habit when the cancel operation is accepted by the cancel operation acceptance unit;
the predetermined processing execution unit executes second predetermined processing corresponding to the second indication candidate; and
the display control unit causes the display unit to display at least one of the second indication candidate and an execution content of the second predetermined processing.

4. The voice operation system according to claim 1, wherein the voice operation system is used to indicate a search condition for a destination in a navigation device;
when a common name to a plurality of shops is extracted as the indication element indicating a destination, the indication candidate determination unit determines the first indication candidate indicating, as a first search condition for the destination, a shop which has been previously used by the user among the plurality of shops; and
the predetermined processing execution unit executes, as the first predetermined processing, processing of searching the shop which has been previously used by the user, based on the behavioral habit of the user according to the first search condition.

5. The voice operation system according to claim 3, wherein the voice operation system is used to indicate a destination in a navigation device;
when a common name to a plurality of shops is extracted as the indication element indicating a destination, the indication candidate determination unit determines the first indication candidate indicating, as a first search condition for the destination, a shop which has been previously used by the user among the plurality of shops, and when the cancel operation is accepted by the cancel operation acceptance unit, by utilizing, as the selection condition, a condition of being closest to a current place of the navigation device, the indication candidate determination unit determines the second indication candidate indicating a shop closest to the current place of the navigation device among the plurality of shops as a second search condition for the destination; and
the predetermined processing execution unit executes, as the first predetermined processing, processing of searching the shop which has been previously used by the user, based on the behavioral habit of the user according to the first search condition, and executes, as the second predetermined processing, processing of searching the shop closest to the current position of the navigation device according to the second search condition.

6. A voice operation device including a display unit and an utterance recognition unit for recognizing an utterance of a user, comprising:
a behavioral habit estimation unit for estimating a behavioral habit of the user;
an indication candidate determination unit for extracting an indication element contained in an utterance of the user when the utterance of the user is recognized by the utterance recognition unit, and determining a first indication candidate which is a candidate of an indication content intended by the user based on the indication element and the behavioral habit of the user estimated by the behavioral habit estimation unit when the indication content intended by the user cannot be specified from the indication element;
a predetermined processing execution unit for executing first predetermined processing corresponding to the first indication candidate; and
a display control unit for causing the display unit to display at least one of a content of the first indication candidate and an execution content of the first predetermined processing.

7. A voice operation control method to be executed by a single or a plurality of computers, comprising:
an utterance recognition step of recognizing an utterance of a user;
an indication element extraction step of extracting an indication element contained in an utterance of the user when the utterance of the user is recognized;
a behavioral habit estimation step of estimating a behavioral habit of the user;
an indication candidate determination step of determining a first indication candidate which is a candidate of an indication content intended by the user based on the indication element and the behavioral habit of the user estimated by the behavioral habit estimation step when the indication content intended by the user cannot be specified from the indication element;
a predetermined processing execution step of executing first predetermined processing corresponding to the first indication candidate; and
a display control step of causing a display unit to display at least one of a content of the first indication candidate and an execution content of the first predetermined processing.

8. A recording medium having a voice operation control program recorded therein, the non-transistor recording medium being installed in a single or a plurality of computers, the voice operation control program causing the single or the plurality of computers to execute:
utterance recognition processing of recognizing an utterance of a user;
indication element extraction processing of extracting an indication element contained in an utterance of the user when the utterance of the user is recognized;
behavioral habit estimation processing of estimating a behavioral habit of the user;
indication candidate determination processing of determining a first indication candidate which is a candidate of an indication content intended by the user based on the indication element and the behavioral habit of the user estimated by the behavioral habit estimation processing when the indication content intended by the user cannot be specified from the indication element;
predetermined processing execution processing of executing first predetermined processing corresponding to the first indication candidate; and
display control processing of causing a display unit to display at least one of a content of the first indication candidate and an execution content of the first predetermined processing.
